(19) United States
(12) Patent Application Publication
(10) Pub. No.: US 2006/0291636 A1
(43) Pub. Date: Dec. 28, 2006

(54) System and method for providing internet busy call treatment

(75) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/143,519

(22) Filed: Jun. 2, 2005

(51) Int. Cl. H04M 3/42

(52) U.S. Cl. 379/201.01

(57) ABSTRACT

A method for providing called party phone line availability information to a calling party terminal attempting to call a called party terminal is provided. The method includes determining that the called party phone line is busy and engaged in an Internet call session, and sending the calling party terminal an Internet-busy notification indicating that the called party phone line is busy and engaged in an Internet call session, and providing Internet call session duration information to the calling party terminal which can indicate how much time is remaining in the Internet call session.

### BACKGROUND OF THE INVENTION

This invention relates to a method and apparatus for providing called party phone line availability information via a telecommunications network to a calling party terminal attempting to call the called party.

While the invention is particularly directed to the art of telecommunications networks, and will be thus described with specific reference thereto, it will be appreciated that the invention may have usefulness in other fields and applications.

By way of background, telecommunications networks enable an efficient means of communication between a calling party and a called party. Typically, when a calling party calls a called party and the called party phone line is not in use, the telecommunications network establishes a call session connecting the two parties.

However, many people only have a single phone line and use a dial up connection, also referred to as a modem connection, to connect their computer with the Internet. Typically, the computer dials the phone line of an Internet Service Provider and is connected to the Internet via the phone line. However, this can tie up the phone line and prevent others, such as the calling party, from contacting the called party.

Further, the called party may be logged onto the Internet for an extended time. When the calling party calls, they only receive a conventional busy signal which doesn't convey to them that the called party is on the Internet and may be for some time. As a result, the calling party may end up calling the called party repeatedly in an effort to reach them, which can be frustrating.

The present invention contemplates a new and improved system and method that resolves the above-referenced difficulties and others.

### SUMMARY OF THE INVENTION

A method and apparatus for providing called party availability information to a calling party terminal are provided.

In one aspect of the invention the method includes determining that a called party phone line is busy and engaged in an Internet call session, sending the calling party terminal an Internet-busy notification indicating that the called party phone line is busy and engaged in an Internet call session providing Internet call session estimated duration information to the calling party terminal.

In accordance with another aspect of the invention, the system includes means for determining that a called party phone line is busy and engaged in an Internet call session, means for sending the calling party terminal an Internet-busy notification indicating that the called party phone line is busy and engaged in an Internet call session, and means for providing Internet call session estimated duration information to the calling party terminal.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a portion of a telecommunications network which includes the system described in accordance with the present invention;

FIG. 2 is a flow chart illustrating the method in accordance with the present invention;

FIG. 3 is a flow chart illustrating the method in accordance with the present invention; and

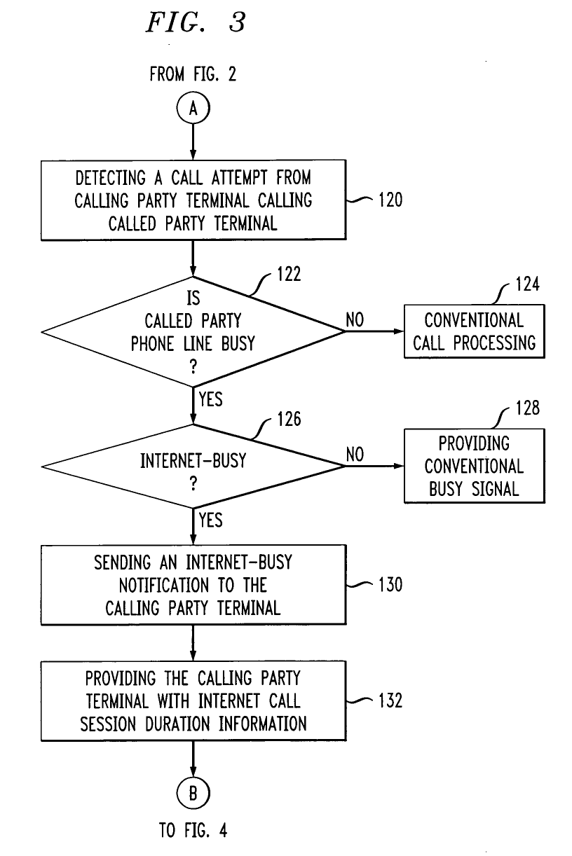

FIG. 4 is a flow chart illustrating the method in accordance with the present invention.

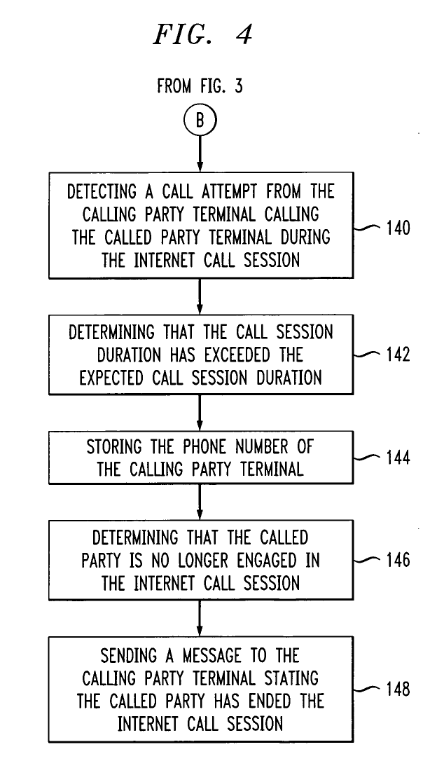

### DETAILED DESCRIPTION OF THE PREFERRED EMBODIMENTS

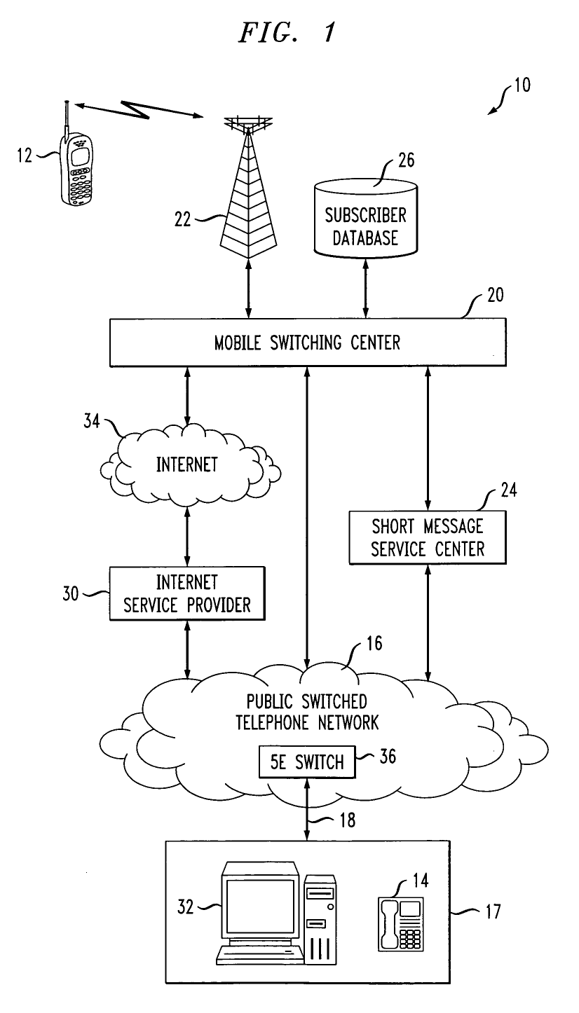

Referring now to FIG. 1 a portion of a telecommunications network is shown generally at 10 for providing wireless telecommunications services to a calling party terminal 12, also referred to as a mobile terminal or cellular phone. The telecommunications network 10 enables the calling party terminal 12 to communicate with a called party terminal 14 via a call session connecting the terminals. The called party terminal 14 can be a landline terminal or other terminal using the Public Switched Telephone Network (PSTN) 16. The called party, shown generally at 17, has a single phone line 18 enabling a single call session to be formed at one time.

The telecommunications network 10 also includes a Mobile Switching Center (MSC) 20 responsible for handling the wireless communications to and from the mobile terminal 12 including such known functions as call setups and call routing, among others. The MSC 20 is typically connected to several base stations, one of which is shown at 22, each providing coverage for different geographic areas so as to provide over-the-air communications between the MSC 20 and wireless terminals located near them.

The MSC 20 can transmit data and/or text messages to the mobile terminal 12, as is known in the art. For example, the MSC 20 can include, or is connected to, a Short Message Service Center (SMSC) 24 for sending SMS messages to the mobile terminal 12 as described below.

The wireless telecommunications network 10 also includes subscriber database 26. The subscriber database can be disposed at the MSC 20, or on other nodes in the network 10. The subscriber database 26 can include individual subscriber records, current status of subscribers, and information on call routing and billing. The subscriber database 26 can include the features which the subscriber subscribes to and can be used to determine whether a subscriber, such as the calling party, is authorized to use the Internet-busy Call Treatment feature described herein.

An Internet Service Provider (ISP) is shown at 30 for connecting a called party computer 32 to the Internet 34. The called party computer 32 uses a modem connection, also referred to as a dial-up connection, to connect the computer 32 to the ISP 30. The modem connection creates a call session, referred to herein as an Internet call session, connecting the called party phone line 18 to the ISP 30 via the PSTN 16. A PSTN switching center 36, such as for example a 5ESS switching center, establishes the Internet call session when the called party computer 32 dials the ISP phone number. As described herein the called party 17 has a single phone line 18 for connecting both the called party terminal 14 and called party computer 32 to the PSTN 16. Therefore, when the called party 17 has established an Internet call session, the called party terminal 14 cannot be used for voice communications in a separate call session.

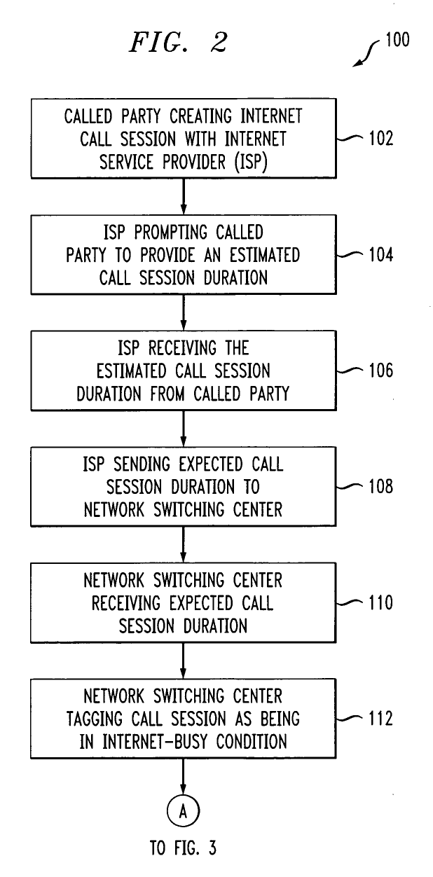

Referring now to FIG. 2 a method for providing called party availability information is shown generally at 100. A called party 17 logs onto the Internet using a dialup, or modem, connection connecting their computer 32 to their phone line 18. The called party computer 32 dials the phone number for the called party's ISP 30 and the PSTN switching center 36 establishes an Internet call session between the ISP and the called party phone line 18 at 102 connecting the called party computer 32 to the Internet 34.

The ISP 30 prompts the called party to provide an estimation of how long they expect to be logged onto the Internet via their current call session at 104. This estimation is referred to herein as the expected Internet call session duration. The called party can provide the expected Internet call session duration to the ISP 30 via their computer 32. The ISP 30 receives the expected Internet call session duration at 106 and sends it to the PSTN switching center 36 at 108. The ISP sends a new message to the PSTN that contains the IP address of 32. The PSTN does a look up in the active call records matching on IP address and updates the appropriate entry with the call duration information.

The switching center 36 tags the call session as being busy by placing an Internet-busy indicator in the call record at 112. The Internet-busy indicator is differentiated from a normal busy indicator, that is the typical busy indicator used to indicated that the phone line is busy, in order to indicate that the call session is an Internet call session. The call record, also known as a call detail record, or call management record, contains information about the call session such as extension number, trunk id, and dialed number.

When the calling party terminal 12 calls the called party terminal 14, the MSC 20 responsible for handling call setups attempts to create a call session connecting the phone lines of the calling party and the called party. During call setup, the MSC 20 communicates with the PSTN switching center 36. The PSTN switching center 36 detects the call attempt from the calling party terminal calling the called party terminal at 120. The switching center 36 determines that the called party phone line is busy at 122, and that the call session is an Internet-busy condition at 126 by detecting the Internet-busy indicator in the call record. Had the called party phone line not been busy, normal call processing would have occurred at 124 connecting the calling party with the called party. Had the call session not been determined to be in an Internet-busy condition at 126, a conventional busy signal would have been sent to the MSC 20 and then to the calling party terminal 12 at 128.

When the call session is determined to be in an Internet-busy condition at 126 the switching center 36 provides an Internet-busy notification to the calling party terminal, via the MSC 20, at 130 indicating that the called party phone line 18 is busy and engaged in an Internet call session. The Internet-busy notification is differentiated from other busy signals, which indicate that the called party phone line is busy, to convey to the calling party that the called party is on the Internet. This Internet-busy notification can be a recorded, or computer generated voice signal stating that the called party phone line is busy engaged in an Internet call session.

The switching center 36 also provides the calling party terminal 12 with Internet call session duration information at 132 in a similar manner such as using a computer generated voice message. The Internet call session duration information can include an estimation of the time remaining in the called party's Internet call session using the expected call session duration provided in 108 above. The Internet call session duration information can include the expected call session termination time using the expected call session duration provided in 108 above.

If the calling party terminal 12 calls the called party terminal 14 again, during the call session, this call attempt is detected at 140. The switching center 36 determines that the actual call session duration has exceeded the expected call session duration at 142 and stores the phone number for the calling party terminal at 144. After the Internet call session is terminated by the called party, the switching center determines that the called party is no longer engaged in the Internet call session at 146 and sends a message to the calling party terminal stating that the called party terminal has ended the Internet call session at 148. The message can be another voice message sent to the called party terminal 12, or an SMS message.

The system and method for providing called party availability information enables a calling party to be notified that the called party they are trying to contact is engaged in an Internet call session. The calling party is also provided with Internet call session duration information informing them of how much longer the called party expects to be on the Internet and/or when the called party expects to end the Internet call session.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for providing called party availability information via a telecommunications network to a calling party terminal attempting to call a called party terminal comprising:
determining that a called party phone line is busy and engaged in an Internet call session;
sending the calling party terminal an Internet-busy notification indicating that the called party phone line is busy and engaged in an Internet call session, wherein the Internet-busy notification is differentiated from other busy signals which indicate the phone line is busy; and
providing Internet call session duration information to the calling party terminal.

2. The method defined in claim 1 wherein the Internet call session duration information includes an estimation of the time remaining in the called party's Internet call session.

3. The method defined in claim 1 wherein the Internet call session duration information includes an expected call session termination time.

4. The method defined in claim 1 further comprising receiving an expected Internet call session duration provided by the called party.

5. The method defined in claim 1 wherein the Internet call session includes the called party terminal and an Internet Service Provider (ISP) for connecting the called party to the Internet, the method further comprising:

6. The method defined in claim 1 further comprising:
the ISP receiving an expected Internet call session duration provided by the called party; and
the ISP sending the expected Internet call session duration to a telecommunications switching center for use in providing the Internet call session duration information.

7. The method defined in claim 1 further comprising:
tagging the call session as an Internet call session.

8. The method defined in claim 1 further comprising:
tagging the call session as being in an Internet-busy condition.

9. The method defined in claim 8 wherein the tagging step further comprises placing an Internet-busy indicator in the call record.

10. The method defined in claim 4 further comprising:
determining that the duration of the Internet call session has exceeded the expected Internet call session duration;
detecting a call attempt from the calling party terminal calling the called party terminal during the Internet call session after the expected call session duration is exceeded;
storing the phone number of the calling party terminal; and
determining that the called party is no longer engaged in the Internet call session;
sending a message to the calling party terminal including a notification that the called party has ended the Internet call session.

11. The method defined in claim 10 wherein the sending step includes sending an SMS message.

12. A method for providing called party availability information via a telecommunications network to a calling party terminal attempting to call a called party terminal comprising:
creating an Internet call session between a called party terminal and an Internet Service Provider (ISP) for connecting the called party to the Internet;
receiving an expected call session duration from the ISP describing the length of time the called party expects the Internet call session to last;
detecting a call attempt from a calling party terminal calling the called party terminal during the Internet call session;
determining that the called party terminal phone line is busy and engaged in the Internet call session with the ISP;
determining an estimated time remaining in the Internet call session using the expected call session duration;
sending an Internet busy notification to the calling party terminal notifying the calling party that the called party is engaged in an Internet call session; and
providing the calling party terminal with the estimated time remaining in the Internet call session.

13. A system for providing called party availability information via a telecommunications network to a calling party terminal attempting to call a called party terminal comprising:
means for determining that a called party phone line is busy and engaged in an Internet call session;
means for sending the calling party terminal an Internet-busy notification indicating that the called party phone line is busy and engaged in an Internet call session, wherein the Internet-busy notification is differentiated from other busy signals indicating the phone line is busy; and
means for providing Internet call session duration information to the calling party terminal.

14. The system defined in claim 13 wherein the means for determining further comprises:
means for determining that a call record associated with the Internet call session indicates that the phone line is busy and engaged in an Internet call session.

15. The system defined in claim 13 further comprising:
means for prompting the called party to provide expected Internet call session duration information;
means for receiving the expected Internet call session duration information for use in providing the Internet call session duration information.

16. The system defined in claim 15 further comprising:
means for determining that the duration of the Internet call session has exceeded the expected Internet call session duration;
means for detecting a call attempt from the calling party terminal calling the called party terminal during the Internet call session after the expected call session duration is exceeded;
means for storing the phone number of the calling party terminal; and
means for determining that the called party is no longer engaged in the Internet call session; and
means for sending a message to the calling party terminal including a notification that the called party has ended the Internet call session.

17. The system defined in claim 13 wherein the means for providing the Internet call session duration information comprises means for sending an Short Message Service (SMS) message to the calling party terminal.
